(19) United States
(12) Patent Application Publication
(10) Pub. No.: US 2009/0278679 A1
(43) Pub. Date: Nov. 12, 2009

(54) Methods and Media for Event Notification in Information Handling Systems

(75) Inventors: James Dailey, Round Rock, TX (US); Lakshmipriya Kothandaraman, Pflugerville, TX (US); Alok Pant, Cedar Park, TX (US); Balasingh Samuel, Round Rock, TX (US)

Correspondence Address: ANDREA E. TRAN;PRAMUDJI WENDT & TRAN, LLP, 1800 BERING DRIVE, SUITE 540, HOUSTON, TX, 77057, US

(73) Assignee: DELL PRODUCTS L.P., Round Rock, TX (US)

(21) Appl. No.: 12/116,310

(22) Filed: May 7, 2008

(51) Int. Cl. G08B 23/00

(52) U.S. Cl. 340/500

(57) ABSTRACT

A method for providing event notification to an application is disclosed. The method may include sending a message to an operating system (OS) driver when a first event occurs. Code in a BIOS associated with the first event may be executed after the OS driver receives the message. A first notification generated by the BIOS may be provided to the OS driver.

### BACKGROUND

1. Technical Field

The present disclosure relates generally to the field of information handling systems. More specifically, but without limitation, the present disclosure relates to providing event notification in an information handling system.

2. Background Information

As the value and use of information continues to increase, individuals and businesses seek additional ways to process and store information. One option available to users is an information handling system (IHS). An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for such systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A portable IHS may include devices such as a laptop, a personal digital assistant (PDA), a cell phone, a smart phone, a MP3 player, a handheld device, or the like. As a result of weight and size concerns, a keyboard on a portable IHS may be smaller and may provide fewer keys than a desktop or non-portable IHS. In order to provide keys that may be available on a full-size keyboard, portable IHSs may utilize a Fn (or function) key in combination with other keystrokes to provide additional keys or features. For example, utilizing an Fn key and keys provided on a portable IHS, the functionality of a number pad from a full-sized keyboard may be provided on the portable IHS.

A scan code may be generated by a keyboard when a key is actuated such as when it is pressed, held down, or released. Each scan code may represent a particular keystroke, such as a letter, a number, a symbol, or a special function key on the keyboard. A special scan code may be generated for a special key or a special combination of keys, sometimes referred to as hotkeys. The scan codes may be broadcasted utilizing standard Windows messages, which may expose the scan codes to an operating system (OS) and all other applications. A potential conflict may arise if the same scan code is shared by more than one application, the same scan code is shared by the OS and applications, or the OS fails to pass the scan code along. By way of example only, an optical disk drive in an IHS may utilize an Fn+F10 keystroke to eject a disk from the drive. However, a multi-disk software installer running on the IHS may utilize the same Fn+F10 keystroke for another purpose different from ejecting the optical disk drive. As a result of the conflict, the software installer may prevent the Fn+F10 keystroke from ejecting the disk from the optical drive. In some optical drives, an eject button may not be present, because software may be utilized to control ejection operations, making removal of a first software installer disk difficult. Hence, the installation operation may be impaired and the user may need to find an alternative means of removing the first CD.

Thus a need remains for improved methods and media for providing event notification to windows applications utilizing existing operating system drivers. The improved methods and media may prevent an application or an OS from impairing event notification to another application and may improve the efficiency of an event notification process. While scan code events are one type of event that notification may be provided for, the methods and media are in no way limited to scan code events.

### SUMMARY

The following presents a general summary of several aspects of the disclosure in order to provide a basic understanding of at least some aspects of the disclosure. This summary is not an extensive overview of the disclosure. It is not intended to identify key or critical elements of the disclosure or to delineate the scope of the claims. The following summary merely presents some concepts of the disclosure in a general form as a prelude to the more detailed description that follows.

One aspect of the disclosure provides a method for providing event notification to an application. The method may include sending a message to an operating system (OS) driver when a first event occurs. Code in a BIOS associated with the first event may be executed after the OS driver receives the message. A first notification generated by the BIOS may be provided to the OS driver.

Another aspect of the disclosure provides a computer-readable medium having computer-executable instructions for performing a method for providing event notification to an application. The method may include sending a message to an operating system (OS) driver when a first event occurs. Code may be associated with the first event, and the code in a BIOS may be executed after the OS driver receives the message. A first notification generated by the BIOS may be provided to the OS driver.

### BRIEF DESCRIPTION OF THE DRAWINGS

For detailed understanding of the present disclosure, references should be made to the following detailed description of the several aspects, taken in conjunction with the accompanying drawings, in which like elements have been given like numerals and wherein:

FIG. 1 represents a schematic of an information handling system according to the present disclosure;

FIG. 2 represents an illustrative implementation of providing notification of keyboard scan codes in an IHS;

FIG. 3 represents an illustrative implementation of a portable IHS;

FIG. 4 represents an illustrative implementation of a keyboard for a portable IHS; and

FIG. 5 represents an illustrative implementation of event notification in an IHS.

### DETAILED DESCRIPTION

Although the invention as been described with reference to specific implementations, it will be understood by those skilled in the art that various changes may be made without departing from the spirit or scope of the invention. Various examples of such changes have been given in the forgoing description. Accordingly, the disclosure of implementations of the disclosure is intended to be illustrative of the scope of the invention and is not intended to be limiting. It is intended that the scope of the invention shall be limited only to the extent required by the appended claims. For example, to one of ordinary skill in the art, it will be readily apparent that the information handling system discussed herein may be implemented in a variety of implementations, and that the forgoing discussion of certain of these implementations does not necessarily represent a complete description of all possible implementations.

For simplicity and clarity of illustration, the drawings and/or figures illustrate the general manner of construction, and descriptions and details of well known features and techniques may be omitted to avoid unnecessarily obscuring the disclosure.

For purposes of this disclosure, an embodiment of an Information Handling System (IHS) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an IHS may be a personal computer, a network storage device, or any other suitable device and may vary in size, shape, performance, functionality, and price. The IHS may include random access memory (RAM), one or more processing resources such as a central processing unit (CPU) or hardware or software control logic, ROM, and/or other types of nonvolatile memory. Additional components of the IHS may include one or more disk drives, one or more network ports for communicating with external devices as well as various input and output (I/O) devices, such as a keyboard, a mouse, and a video display. The IHS may also include one or more buses operable to transmit data communications between the various hardware components.

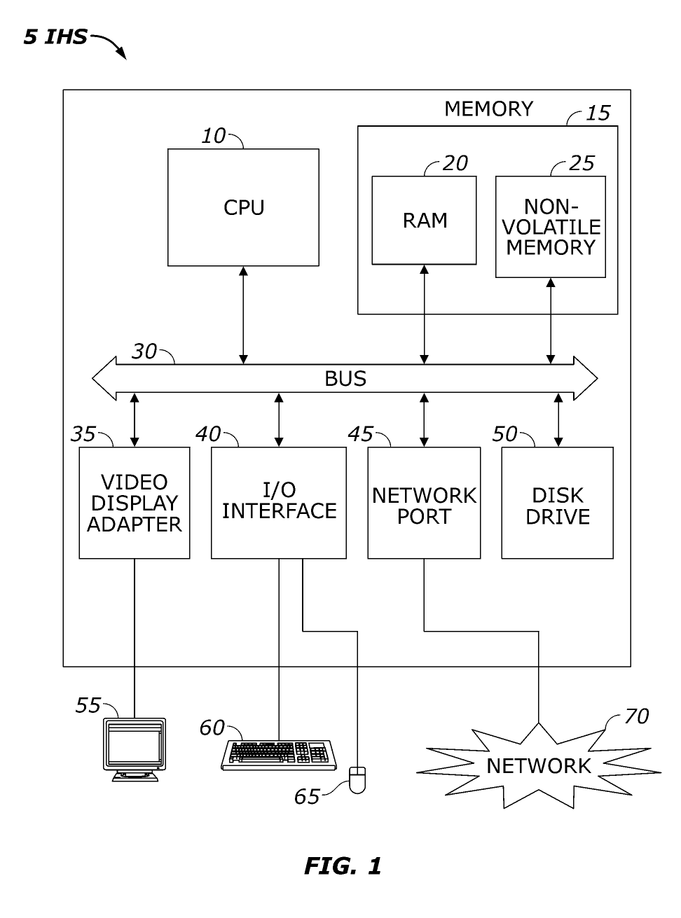

FIG. 1 illustrates one possible implementation of an IHS 5 comprising a CPU 10. It should be understood that the present disclosure has applicability to information handling systems as broadly described above, and is not intended to be limited to the IHS 5 as specifically described. The CPU 10 may comprise a processor, a microprocessor, minicomputer, or any other suitable device, including combinations and/or a plurality thereof, for executing programmed instructions. The CPU 10 may be in data communication over a local interface bus 30 with components including memory 15 and input/output interfaces 40. The memory 15, as illustrated, may include non-volatile memory 25. The non-volatile memory 25 may include, but is not limited to, firmware flash memory and electrically erasable programmable read-only memory (EEPROM). The firmware program (not shown) may contain, programming and/or executable instructions required to control a keyboard 60, mouse 65, video display 55 and/or other input/output devices not shown here. The memory may also comprise RAM 20. The operating system and application programs may be loaded into the RAM 20 for execution.

The IHS 5 may be implemented with a network port 45 to permit communication over a network 70 such as a local area network (LAN) or a wide area network (WAN), such as the Internet. As understood by those skilled in the art, IHS 5 implementations may also include an assortment of ports and interfaces for different peripherals and components, such as video display adapters 35, disk drives port 50, and input/output interfaces 40 (e.g., keyboard 60, mouse 65).

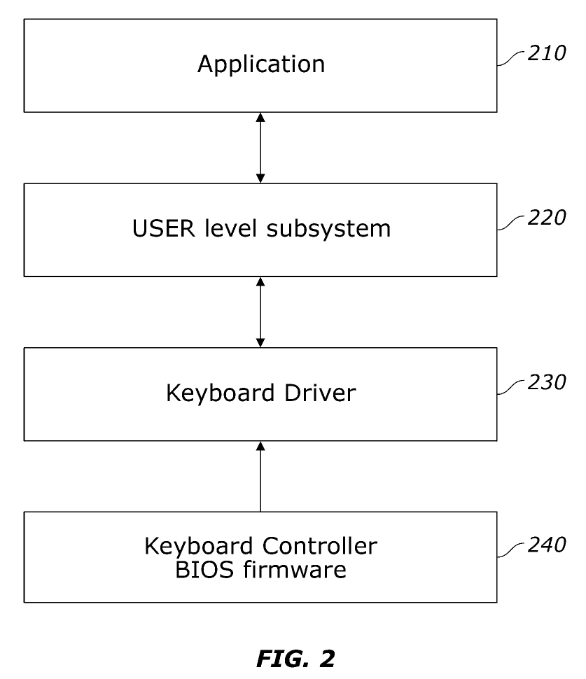

FIG. 2 represents an illustrative implementation of providing notification of keyboard scan codes in an IHS. A scan code may provide data related to the actuation of a key, such as when it is pressed, held down, or released on a keyboard. Some keyboard scan codes may be defined by Microsoft, such as in the Keyboard Scan Code Specification Revision 1.3a. A scan code may be provided by a keyboard to an IHS to indicate keystrokes of a user. For example, each key may represent a number, a letter, a symbol, a function, a command, or the like. A special scan code may be assigned to special key(s) or a special combination of keys, sometimes referred to as hot keys, which may be utilized to provide special functions in an IHS.

A keyboard controller/BIOS firmware 240 in an IHS may receive one or more scan codes from the standard keyboard port, such as a PS/2 port or a USB port, whenever a key is pressed or released. The keyboard controller/BIOS firmware 240 may temporarily store the scan codes in a buffer or register until the scan codes can be retrieved by a keyboard driver 230. The keyboard driver 230 may read the scan code and send it to user level subsystem 220, such as Win32 subsystem or any suitable application programming interfaces (APIs). The user level subsystem 220 may broadcast the scan code, such as a traditional scan code or a Windows virtual key, to applications 210 using a standard Windows messaging. Each of the applications 210 may be a windows type or any suitable application registered to receive scan code notifications.

However, several applications 210 may be registered to receive scan codes from the OS. In some cases, a manufacturer of an application 210 may utilize undefined scan codes to provide a hot key function. For example, a Dell QuickSet application may utilize undefined scan codes to provide hot keys that may allow a user to display battery properties, increase/decrease volume, mute, adjust screen brightness, and several additional tasks. However, applications 210 or the OS may create a conflict by utilizing the same scan codes or the OS may fail to pass scan codes to the application 210. As a result, the broadcasted scan code may never reach an intended application which may prevent the application 210 from performing desired functions or commands. In addition, utilizing this process to register for notification of scan codes may be inefficient because an application 210 may register with an OS to receive scan codes for every keystroke, but the OS may not allow the application to specify a few scan codes of interest. Consequently, the application 210 may need to filter through the received scan codes to find relevant scan codes.

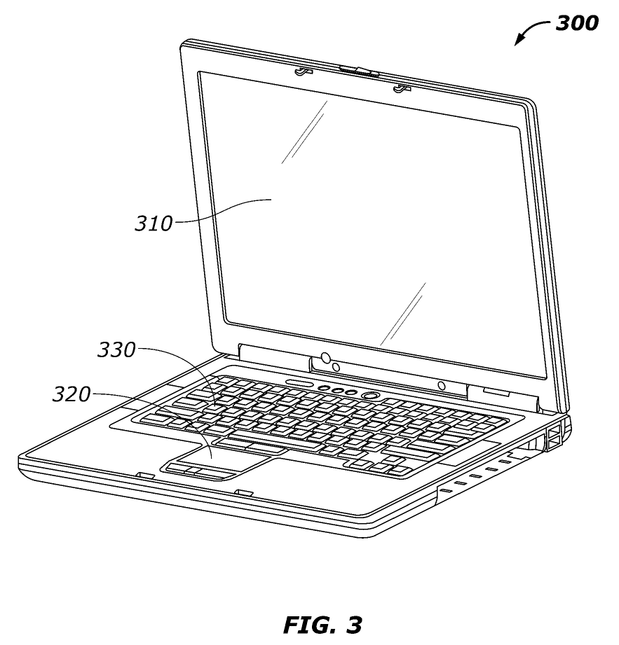

FIG. 3 provides an illustrative implementation of a portable IHS. A portable IHS 300 may include a display 310, a touch pad 320, a keyboard 330, a CPU (not shown), and memory (not shown). Several additional components, such as the components discussed regarding an IHS, may be present in a portable IHS as well. A portable IHS 300 may also include software components such as an operating system (OS), drivers, firmware, a basic input/output system (BIOS), applications, programs, or the like. A user may operate input devices such as a touch pad 320, a mouse (not shown), or a keyboard 330 in order control and implement functions and operations provided by the portable IHS 300.

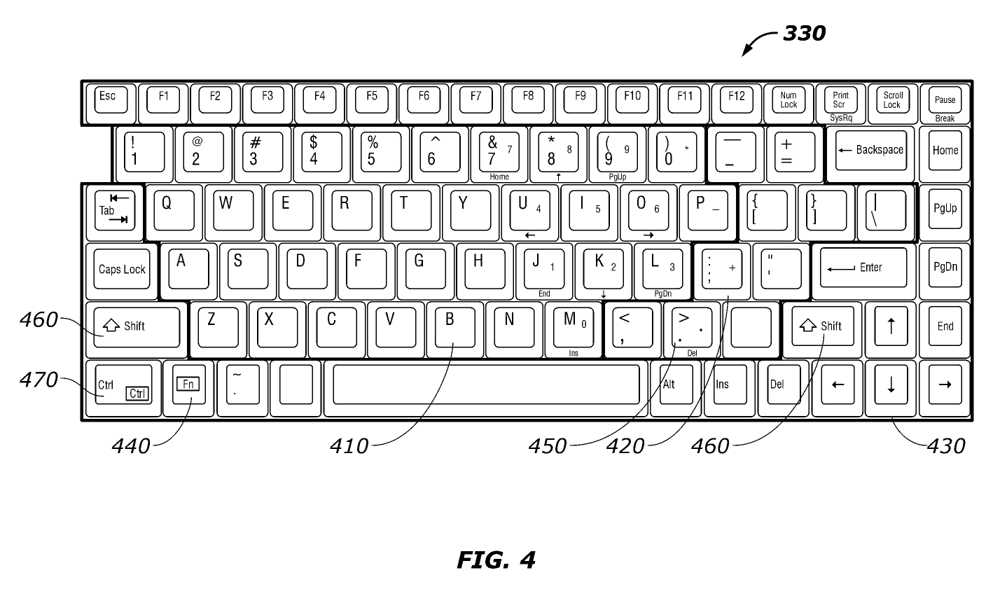

FIG. 4 represents an illustrative implementation of a keyboard for a portable IHS. A keyboard 330 may provide several different types of keys, examples including an alpha-numeric key indicated generally at 410, a symbol key indicated generally at 420, and a special key indicated generally at 430. In some keyboards 330, a scan code may be sent when a key is pressed and/or released or may be repeatedly sent if a key is held down. A scan code may provide data representing a key pressed by a user. An IHS may utilize the scan code to determine an operation to be performed in response to a particular keystroke. Several keys may provide more than one alpha-numeric character, symbol, or special functions. The additional characters, symbols, or functions for a key may be accessed by pressing a combination of keys. For instance, the period key 450 may also have an “>” near the top, “.” to the right, and “Del” at the bottom of the key. A shift key 460 may be pressed in combination with the period key 450 to output “>”. The “.” on the right side, which may be output by pressing the Fn key 440 simultaneously with the period key 450, may be part of a number pad that may often be provided in a full sized keyboard. The “Del” function may be accessed by pressing a ctrl key 470 with the period key 450.

The additional characters, symbols, and functions which may be accessed by pressing one or more keys or a sequence of keys may often be referred to as hot keys, keyboard shortcut, shortcut key, or the like. As discussed previously, several scan codes may be defined for specific keystrokes and combinations of keystrokes on a keyboard including common hot keys. However, the remaining undefined scan codes may be utilized by a manufacturer to provide additional special features accessed by pressing a special key or a special combination of keys. For example, a portable IHS may provide an application recognizing a hot key, such as pressing an Fn key 440 with the F3 key, for displaying battery properties. When the application receives notification of such keystrokes, it may cause battery properties in a portable IHS to be displayed.

In some cases, a hot key may provide a quick approach for a user to access a special function or feature that may be available by other means in the portable IHS. For instance, an OS may provide information regarding battery properties in a portable IHS when a user accesses a control panel menu and selects a battery property icon. However, by pressing a battery properties hot key (e.g., Fn+F3) a user may access the battery properties without navigating through a control panel menu with a mouse or touch pad. In other cases, a hot key may provide functions that cannot be accessed by other means. For example, a disk eject function, for an optical disk drive without a traditional eject button, may be provided by selecting Fn key 440 and F10. As discussed previously, an OS, applications, and/or programs may utilize the same scan code which may create a conflict that prevents another application from receiving the scan code.

In an event notification method provided in the present disclosure, the drawbacks of keystroke event notification utilizing scan codes may be avoided by eliminating the use of scan codes for event notifications. While the notification of hotkey events is discussed in the present disclosure, the event notification method discussed herein may be capable of providing notification of any event detected by an IHS and is not limited to providing notification of scan code events. An event may occur when a performance characteristics or an operational state of an IHS changes or does not change. The performance characteristics or operational states of various components, including software components, in an IHS may be detected by the BIOS. For example, an IHS may be capable of detecting the temperature of components, a change fan speed, special keystrokes, a non-responsive application, or the like. An event may occur when the temperature of a component rises above a certain level, a fan's speed drops below a predetermined level, a hotkey is pressed, a program does not respond within a certain amount of time, or the like. The event notification method not only provides notice of hotkey events, but may also provide notice of other events in an IHS. An event notification method may also avoid the use of a third party device driver (i.e., a driver created by someone other that the maker of the OS) to provide notifications. Further, an event notification method may allow large chunks of information to be sent to an application without repeated callbacks for additional information and may also ensure that applications receive information about pertinent events without interference from another application.

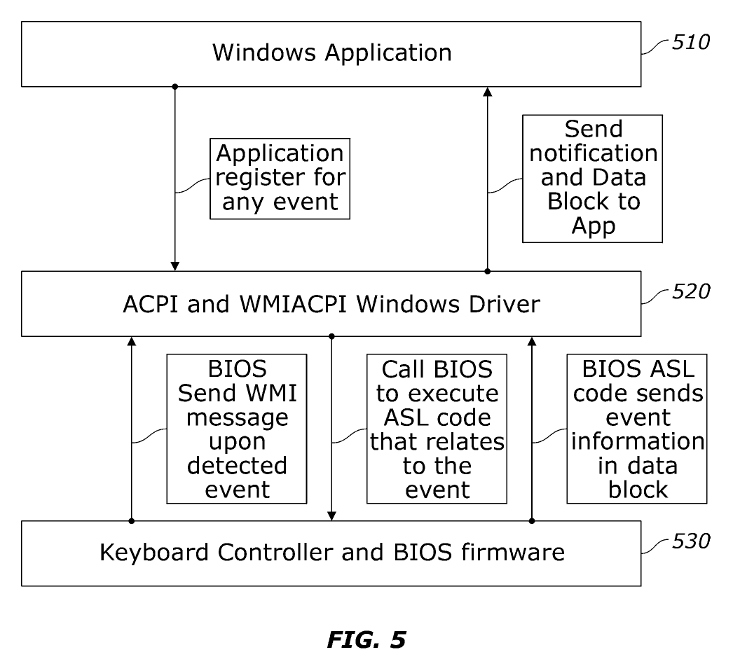

FIG. 5 provides a detailed illustrative implementation of event notification in an IHS. An event notification may be provided to one or more applications without routing the event notification through a user level subsystem and/or a third party device driver. In an IHS, performance characteristics and operational states of hardware and/or software may be detected by the BIOS or OS, and notification of certain events may be provided to one or more applications. In response to the notification of a certain event, an application may wish to initiate a corresponding operation in the IHS. For

In order for an application to receive notification of an event, a keyboard controller/BIOS firmware 530 may be coupled to an advanced configuration and power interface (ACPI) driver and a windows management instrumentation-advanced configuration and power interface (WMI-ACPI) driver 520 which may be coupled to one or more applications 510. The keyboard controller may be part of the BIOS firmware 530, and together the keyboard controller/BIOS firmware 530 may be responsible for power management in a portable IHS. For instance, the keyboard controller/BIOS firmware 530 may detect the insertion and removal of components and manage battery charging. The ACPI specification may define common interfaces that enable OS directed device/system configuration and power management. An ACPI driver may be a kernel space driver which may provide common interfaces for ACPI operations. An ACPI driver may allow information from the BIOS to be provided to the OS utilizing ACPI source language (ASL) or ACPI machine language (AML). ASL may be a coding language and AML may be a compiled language utilized to describe an IHS's properties in accordance with the ACPI specifications. For example, an ACPI driver may indicate to the OS utilizing AML that certain components are not in use, which may allow the OS to power down these components, such as a monitor or a drive. A WMI-ACPI driver may allow information in an ACPI format to be translated into a windows management instrumentation (WMI) format. WMI provides an implementation of web-based enterprise management (WBEM) and common information model (CIM) protocols supplied by the Distributed Management Task Force (DMTF). WMI may provide a set of extensions to the windows driver model which allows components in an IHS to provide notification and other information to an OS interface. The information may then be retrieved from the OS interface and shared by several applications. Both the ACPI driver and the WMI-ACPI driver may be OS drivers, or in other words, the drivers may be provided by the OS.

When an event occurs, such as a Fn+F10 keystroke, a keyboard controller/BIOS firmware 530 may send an ACPI-WMI message to the ACPI and ACPI-WMI drivers 520. The keyboard controller/BIOS firmware 530 may utilize ACPI methods that may be converted by the OS into WMI messages. For example, a BIOS firmware 530 may generate a system control interrupt (SCI) and provide a globally unique identifier (GUID) or a 16-bit unicode string identifying a WMI object representing a particular event of interest to the OS. One or more applications 510 may be registered with the ACPI and ACPI-WMI drivers 520 to receive notification of the particular event. For example, an application 510 may register with the ACPI and ACPI-WMI drivers 520 to receive notification when the 16-bit unicode string is received by the OS. When the ACPI and ACPI-WMI drivers 520 receive notification of the particular event, the ACPI and ACPI-WMI drivers 520 may call on the [keyboard controller/] BIOS firmware 530 to execute ASL code or AML code associated with the particular event. The [keyboard controller/] BIOS firmware 530 may send a notification generated by executing the ASL/AML code to the ACPI and ACPI-WMI drivers 520. The notification, including any additional data associated with the detected event, may be stored in a buffer (not shown) available to applications registered to receive notifications of the particular event. For instance, the additional data may include device presence and absence information, device insertion and removal information, status information, messages to be display to a user, or messages to be provided to an operating system. The buffer may be any suitable capacity, such as a capacity in the large range of 4 KB to 2 MB, and may allow a large amount of data to be provided to applications. The additional data may provide further information related to a particular event such as performance data or operational state data.

By utilizing an existing WMI-ACPI driver and ACPI driver 520, the use of a third party driver and scan codes may be avoided when providing hotkey event notifications. Further, by providing a large buffer, multiple notifications may be sent simultaneously and a large chunk of data may be sent to an application. This may allow event notifications to be provided without requiring multiple callback system management interrupts (SMIs) to retrieve additional data. The large buffer may also allow notifications to be provided in the order the events occurred, preventing any potential ordering errors. The event notification method also allows an application to register for a specific scan code. This may allow the application to operate more efficiently by avoiding the need to filter out unwanted scan code. Additionally, utilizing an ACPI driver and WMI-ACPI driver may also prevent other applications from terminating or interfering with notification of a particular event, whereas an application may prevent scan codes from being transmitted to other applications.

Various methods are contemplated including all or less than all of the steps described herein and/or discussed above, any number of repeats, and performance of the steps in any order.

Methods of the present disclosure, detailed description and claims may be presented in terms of logic, software or software implemented aspects typically encoded on a variety of media or medium including, but not limited to, computer-readable medium/media, machine-readable medium/media, program storage medium/media or computer program product. Such media may be handled, read, sensed and/or interpreted by an IHS. Those skilled in the art will appreciate that such media may take various forms such as cards, tapes, magnetic disks (e.g., floppy disk or hard drive) and optical disks (e.g., compact disk read only memory (“CD-ROM”) or digital versatile disc (“DVD”)). It should be understood that the given implementations are illustrative only and shall not limit the present disclosure.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, and/or use of equivalent functional junctions for couplings/links described herein.

What is claimed is:

1. A method for providing event notification to an application, the method comprising:
sending a message to an operating system (OS) driver when a first event occurs;
executing code in a BIOS after the OS driver receives the message, wherein the code is associated with the first event; and
providing a first notification generated by the BIOS to the OS driver.

2. The method of claim 1 further comprising:
registering a first application with the OS driver for notification of the first event; and
providing the first notification to the first application when the first event occurs.

3. The method of claim 2, wherein the first notification in supplied in a buffer accessible by the first application, and the buffer is in a size range between 4 KB and 2 MB.

4. The method of claim 1, wherein the message is a windows management instrumentation (WMI) message.

5. The method of claim 1, wherein the code in the BIOS is an ACPI (advance configuration and power interface) source language (ASL) code or an ACPI machine language (AML) code.

6. The method of claim 1, wherein the first notification includes additional data, and the additional data provides device presence and absence information, device insertion and removal information, status information, messages to be display to a user, or messages to be provided to an operating system.

7. The method of claim 1, wherein the OS driver comprises an advanced configuration and power interface (ACPI) and a windows management instrumentation-advanced configuration and power interface (WMI-ACPI) driver.

8. The method of claim 1, wherein a third party driver is not required to send a first notification.

9. The method of claim 3 further comprising:
providing a plurality of notifications associated with a plurality of events in the buffer.

10. The method of claim 9 further comprising:
Storing the plurality of notifications in an order in which the plurality of events are detected.

11. A computer-readable medium having computer-executable instructions for performing a method for providing event notification to an application, the method comprising:
sending a message to an operating system (OS) driver when a first event occurs;
executing code in a BIOS after the OS driver receives the message, wherein the code is associated with the first event; and
providing a first notification generated by the BIOS to the OS driver.

12. The computer-readable medium of claim 11, wherein the method further comprises:
registering a first application with the OS driver for notification of the first event;
providing the first notification to the first application when the first event occurs.

13. The computer-readable medium of claim 12, wherein the first notification is supplied in a buffer accessible by the first application, and the buffer is in a size range between 4 KB and 2 MB.

14. The computer-readable medium of claim 11, wherein the message is a windows management instrumentation (WMI) message.

15. The computer-readable medium of claim 11, wherein the code in the BIOS is an ACPI (advance configuration and power interface) source language (ASL) code or an ACPI machine language (AML) code.

16. The computer-readable medium of claim 11, wherein the first notification includes additional data, and the additional data provides device presence and absence information, device insertion and removal information, status information, messages to be display to a user, or messages to be provided to an OS.

17. The computer-readable medium of claim 11, wherein the OS driver is an advanced configuration and power interface (ACPI) and a windows management instrumentation-advanced configuration and power interface (WMI-ACPI) driver.

18. The computer-readable medium of claim 11, wherein a third party driver is not required to send the first notification.

19. The computer-readable medium of claim 13, wherein a plurality of notification associated with a plurality of events may be provided in the buffer.

20. The computer-readable medium of claim 19, wherein the plurality of notifications are stored in an order in which the plurality of events are detected.
